(19) United States
(12) Patent Application Publication
(10) Pub. No.: US 2025/0223676 A1
(43) Pub. Date: Jul. 10, 2025

(54) Grain-Oriented Electrical Steel Sheet Coated with a Resin and Used for Stacking

(71) Applicant: ThyssenKrupp Electrical Steel GmbH, Gelsenkirchen (DE)

(72) Inventors: Christian Hecht, Mülheim an der Ruhr (DE); Paul Betken, Bochum (DE); Lars Lueneberg, Moers (DE)

(21) Appl. No.: 19/095,622

(22) Filed: Mar. 31, 2025

(30) Foreign Application Priority Data
Jan. 17, 2025 (EP) 25152487.2
Jan. 17, 2025 (IN) 202514004125

(51) Int. Cl. C22C 38/02; B32B 7/12; B32B 15/01; C21D 6/00; C21D 8/12; C22C 38/00; C22C 38/04; C22C 38/06; C22C 38/16

(52) U.S. Cl. CPC C22C 38/02; B32B 7/12; B32B 15/011; C21D 6/008; C21D 8/1222; C21D 8/1233; C21D 8/1255; C21D 8/1261; C21D 8/1272; C21D 8/1283; C22C 38/001; C22C 38/002; C22C 38/04; C22C 38/06; C22C 38/16; B32B 2311/30; B32B 2457/00; C21D 2201/05

(57) ABSTRACT

A grain-oriented electrical steel having a yield strength in the rolling direction of at least 340 MPa determined according to DIN EN ISO 6892-1 and a polarization J500 of at least 1.85. The disclosure further relates to a method of producing a grain-oriented electrical steel sheet, to laminated stacks of grain-oriented electrical steel sheets, with the stack including at least two grain-oriented electrical steel sheets laminated together with a resin, and to the use of the grain-oriented electrical steel sheet as material for the production of parts for electric motors, preferably as material for the production of stator or rotor teeth in radial flux motors.

### CROSS-REFERENCE TO RELATED APPLICATIONS

This application claims priority to European Patent Application No. 25152487.2 filed Jan. 17, 2025, and Indian Patent Application number 202514004125 filed Jan. 17, 2025, the disclosures of which are hereby incorporated by reference in their entireties.

### BACKGROUND OF THE INVENTION

### Field of the Invention

The present invention relates to a method for producing a grain-oriented electrical steel strip, to a grain-oriented electrical steel strip, to a laminated stack of at least two grain-oriented electrical steel strips of the invention and to the use of such a grain-oriented electrical steel strip or laminated stack thereof as material for the production of parts for electric motors, for electric transformers or for other electric devices. In particular, the present invention relates to a grain-oriented electrical steel strip with improved mechanical properties, in particular improved yield strength, and excellent electromagnetic properties.

Unless explicitly stated otherwise, in the present text and the claims the content of particular alloy elements is always reported in % by weight (=“wt.-%”) or on ppm by weight (=“wt.-ppm”).

The terms “sheet” or “strip” are used in the present text synonymously to indicate a flat steel product which is obtained by a rolling process and which length and width is much greater than its thickness. Thus, all explanations given here with regard to a grain-oriented electrical steel sheet also apply for a grain-oriented electrical steel strip and vice versa.

Grain-oriented electrical steel (“GOES”) is a soft magnetic material, which typically exhibits high silicon contents. GOES has a high permeability to the magnetic field and can be magnetized and demagnetized easily.

Their magnetic properties make sheets or strips made from GOES material especially suited for manufacturing electric transformer cores with a minimum specific loss and a high achievable working induction, for example up to 1.85 T, for a wide range of sheet thicknesses, e.g. 0.10 to 0.35 mm.

### DESCRIPTION OF RELATED ART

According to N. Chen et al., Acta Materialia 51 (2003), pages 1755 to 1765 and K. Günther et al., Journal of Magnetism and Magnetic Materials 320 (2008), 2411 to 2422, GOES can be manufactured in different ways. An exemplary production route includes the following manufacturing steps:
a) Producing a steel by using a blast furnace and basic oxygen converter or by using an electric arc furnace;
b) metallurgy refining of the steel melt by using a vacuum degassing vessel;
c) casting the steel melt into an intermediate product, i.e. a common slab, a thin slab or a cast strip;
d) optionally reheating the intermediate product;
e) hot rolling the intermediate product to a hot rolled steel strip;
f) coiling the hot rolled steel strip into a coil;
g) coil surface preparation;
h) hot strip annealing and pickling of the hot rolled strip;
i) cold rolling the hot rolled strip in one or more passes to obtain a cold rolled strip with a final thickness;
j) decarburization annealing of the cold rolled strip;
k) optionally surface nitriding of the cold rolled strip;
l) applying a MgO coating to the surface of the cold rolled strip;
m) high temperature box annealing of the MgO coated cold rolled strip to decarburize the cold rolled strip, the cold rolled strip being coiled to coils which for the box annealing are stacked in a hood type furnace;
n) heat flattening and insulation coating of the annealed strip;
o) optionally magnetic domain refining of the strip.

According to the so called “High Heating” technology, the casting and the high temperature slab reheating is performed at temperatures of up to 1400° C. Such high temperature casting and reheating results in a well-developed inhibition system which comprises particles of AlN, MnS and other compounds in the iron matrix even before the cold process. The presence of said particles promotes an abnormal grain growth in the steel structure, which has a positive effect on the magnetic properties of the GOES sheet.

In the so called “Low Heating” technology the intermediate product is reheated at low temperatures so that no or only a weak inhibition system is formed in the slab before hot rolling. For this reason, in the low heating technology a nitriding treatment of the cold rolled strip surface has to be performed after the decarburization annealing to form an inhibition system, which enables a secondary grain growth in the course of the high temperature box annealing of the cold rolled strip.

The primary recrystallization (PRX) occurring during the decarburization annealing prepares and controls the secondary grain growth. However, this process step is unstable due to the large number of metallurgical phenomena that compete with each other during the decarburization annealing. These phenomena are in particular carbon removal, formation of the oxide layer, primary grain growth.

Nevertheless, it is known that decarburization annealing is essential to obtain efficient nitriding, a high-quality insulating forsterite film, and a sufficient number of Goss nuclei in the matrix. Furthermore, it is known that a dense oxide layer, which occurs during the beginning of decarburization annealing, can promote surface quality but can also act as a barrier to decarburization and nitriding.

In the “Low Heating” process after the decarburization and nitriding step the steel strip runs through a high temperature annealing cycle either in a batch annealing furnace or a rotary batch annealing furnace. In the course of the high temperature annealing step secondary recrystallization (SRX) occurs and an abnormal grain growth takes place which leads to the Goss texture controlled by the inhibitors previously formed. Furthermore, disturbing elements such as sulfur or nitrogen are removed and a forsterite layer, also often called “glass film” is formed on the surface of the strip. This forsterite layer acts as an electric insulation coating layer and applies an additional tension on the surface of the strip, which contributes to the magnetic properties of the strip.

In a further process step, as known for example from DE 22 47 269 C3, a solution based on magnesium phosphate or aluminum phosphate or mixtures of both with various additives, such as chromium compounds and Si oxide, can be applied to the forsterite layer and baked at temperatures above 350° C. The layer system thus formed on the electrical steel forms an insulating layer, which transfers additional tensile stresses to the steel material that have a favorable effect on the electromagnetic properties of the electrical steel or sheet.

To ensure that these tensile stresses are transmitted reliably under harsh operating conditions over a long period of use, excellent adhesion of the forsterite layer to the cold-rolled steel material of the electrical steel strip must be ensured. For example, it must be ensured that the forsterite layer adheres firmly to the steel substrate even when the electrical steel coated with it is wound into a coil or cut to form blanks or other sheet parts required for further processing.

The cores of stators and rotors of conventional radial-flux electric motors are usually made of the same materials. The standard core material used is non-grain-oriented electrical steel sheet (“NGO”). NGO is characterized by better mechanical properties than grain-oriented electrical steel. However, the magnetic properties of GOES are significantly better in the rolling direction than those of NGO.

While it would be a good idea to use GOES for parts of electric motors where the electric flux flows approximately in the rolling direction, the poorer mechanical properties of GOES in comparison to NGO have so far prevented GOES from being used as a rotor material in radial flux motors. The use of GOES as rotor material in radial flux motors would bear the risk of total failure of the motor due to the high rotational speeds that would compromise the integrity of a rotor made of GOES. Therefore, due to the magneto restrictive mechanical requirements that have to be fulfilled by a rotor in radial flux motors, existing GOES are so far only suitable as a stator core material in radial flux motors (cf. DE 10 2019 122365).

### SUMMARY OF THE INVENTION

Against the background of the prior art explained above, the object of the present invention is to provide a method of producing a grain-oriented electrical steel strip, in particular for use in stator and rotor teeth in electric motors, in particular in radial flux motors, with improved mechanical properties, in particular improved yield strength in the rolling direction, without compromising its polarization.

The invention solved this problem by means of a method of producing a grain-oriented electrical steel sheet, a grain-oriented electrical steel sheet, a stack thereof, and the use of the grain-oriented electrical steel sheet or the stack as described herein.

The general idea and advantageous embodiments of the invention are explained in detail below.

The method of producing the grain-oriented electrical steel sheet according to the present invention comprises at least the following working steps:
a) Providing a steel slab with a composition comprising, in wt.-%,
   Si: 2.0 to 4.0,
   C: 0.01 to 0.10,
   Alₛₗ: 0.01 to 0.065,
   N: 0.003 to 0.015,
   Mn: 0.01 to 0.5,
   at least one element selected from the group consisting of P, Cu, Mg, with the following contents, in wt.-%
   P: 0.005 to 0.10,
   Mg: 0.0003 to 0.0020,
   Cu: 0.001 to 0.50;
   optionally one or more elements selected from the group consisting of S, Se, Sn, Sb, Bi, Ni, Cr, Co, Mo, wherein the individual content of each of these elements is 0.005 to 0.2 wt.-%;
   optionally one or more elements selected from the group consisting of As, B, V, Nb, Te, Ti, wherein the individual content of each of these elements is 0.0003 to 0.1 wt.-%; the remainder of the composition being Fe and unavoidable impurities;
b) heating of the steel slab in a furnace to a temperature of at least T1, T2 or T3, in K, and less than 1723 K, preferably less than 1623 K.
   wherein the temperature T1 indicates the minimum heating temperature for a steel slab containing Cu and P and the temperature T1 is calculated using the following equation:

$$T 1 = 1200 + 350 * Cu + 2056 * P$$

wherein the temperature T2 in K indicates the minimum heating temperature for a steel slab containing P and Mg and the temperature T2 is calculated using the following equation:

$$T 2 = 1200 + 250 * P + 10000 * Mg$$

wherein the temperature T3 in K indicates the minimum heating temperature for a steel slab containing Cu and Mg and the temperature T3 is calculated using the following equation:

$$T 3 = 1200 + 350 * Cu + 10000 * Mg ;$$

wherein the minimum heating temperature for a steel slab containing Cu, Mg and P corresponds to the lowest temperature selected from the calculated temperatures T1, T2 and T3.
c) Continuous hot rolling of the steel slab into a hot strip, wherein
   i. the time between the end of rough rolling and the start of final hot rolling is less than 15 s or
   ii, wherein between the end of rough rolling and the start of final hot rolling coiling and/or intermediate annealing of the rough rolled hot strip is carried out;
d) Cooling the hot strip by vapor and/or liquid spray cooling;
e) Coiling the hot strip at a coiling temperature CT, wherein CT conforms to the following equation:

$$TX * 0.66 \leq CT \leq TX * 0.83 ,$$

wherein TX, in K, is selected from T1, T2 or T3 calculated according to step b) above;
f) Annealing the hot strip;
g) Cold rolling the hot strip in one or more steps into a cold strip, wherein the cold rolling optionally comprises an intermediate annealing;
h) Decarburization annealing of the cold strip;
i) Applying an annealing separator onto at least one surface of the cold strip;
j) Final annealing of the cold strip at a maximum soaking temperature of at least 1076° C. but less than 1247° C.;
k) Optionally coating of the annealed cold strip with an electric insulation coating and annealing of the insulation coated cold strip;
l) Optionally performing domain refinement of the coated cold strip.

Also, grain-oriented electrical steel made according to the inventive method, wherein the grain-oriented electrical steel has a yield strength in rolling direction of at least 340 MPa determined according to DIN EN ISO 6892-1 and a polarization J500 of at least 1.85.

### BRIEF DESCRIPTION OF THE DRAWINGS

The invention is explained further using the following FIGURES. The terms FIG., FIGS., Figure, and Figures are used interchangeably in the specification to refer to the corresponding FIGURES in the drawings.

FIG. 1A Schematic illustration of the decoration of grain boundaries in the grain-oriented electrical steel sheet of the prior art;

FIG. 1B Schematic illustration of the decoration of grain boundaries in the grain-oriented electrical steel sheet according to the invention;

FIG. 1C Schematic illustration of the decoration of grain boundaries in a grain-oriented electrical steel sheet with high polarization and poor mechanical properties; and

FIG. 1D Schematic illustration of the decoration of grain boundaries in a grain-oriented electrical steel sheet with poor polarization due to deformation of the hysteresis curve.

### DESCRIPTION OF THE INVENTION

The method of producing the grain-oriented electrical steel sheet according to the present invention comprises at least the following working steps:
a) Providing a steel slab with a composition comprising, in wt.-%,
   Si: 2.0 to 4.0,
   C: 0.01 to 0.10,
   Alₛₗ: 0.01 to 0.065,
   N: 0.003 to 0.015,
   Mn: 0.01 to 0.5,
   at least one element selected from the group consisting of P, Cu, Mg, with the following contents, in wt.-%
   P: 0.005 to 0.10,
   Mg: 0.0003 to 0.0020,
   Cu: 0.001 to 0.50;
   optionally one or more elements selected from the group consisting of S, Se, Sn, Sb, Bi, Ni, Cr, Co, Mo, wherein the individual content of each of these elements is 0.005 to 0.2 wt.-%;
   optionally one or more elements selected from the group consisting of As, B, V, Nb, Te, Ti, wherein the individual content of each of these elements is 0.0003 to 0.1 wt.-%; the remainder of the composition being Fe and unavoidable impurities;
b) heating of the steel slab in a furnace to a temperature of at least T1, T2 or T3, in K, and less than 1723 K, preferably less than 1623 K,
   wherein the temperature T1 indicates the minimum heating temperature for a steel slab containing Cu and P and the temperature T1 is calculated using the following equation:

$$T 1 = 1200 + 350 * Cu + 2056 * P ;$$

wherein the temperature T2 in K indicates the minimum heating temperature for a steel slab containing P and Mg and the temperature T2 is calculated using the following equation:

$$T 2 = 1200 + 250 * P + 10000 * Mg ;$$

wherein the temperature T3 in K indicates the minimum heating temperature for a steel slab containing Cu and Mg and the temperature T3 is calculated using the following equation:

$$T 3 = 1200 + 350 * Cu + 10000 * Mg ;$$

wherein the minimum heating temperature for a steel slab containing Cu, Mg and P corresponds to the lowest temperature selected from the calculated temperatures T1, T2 and T3.
c) Continuous hot rolling of the steel slab into a hot strip, wherein
   i. the time between the end of rough rolling and the start of final hot rolling is less than 15 s or
   ii, wherein between the end of rough rolling and the start of final hot rolling coiling and/or intermediate annealing of the rough rolled hot strip is carried out
d) Cooling the hot strip by vapor and/or liquid spray cooling;
e) Coiling the hot strip at a coiling temperature CT, wherein CT conforms to the following equation:

$$TX * 0.66 \leq CT \leq TX * 0.83 ,$$

wherein TX, in K, is selected from T1, T2 or T3 calculated according to step b) above;
f) Annealing the hot strip;
g) Cold rolling the hot strip in one or more steps into a cold strip, wherein the cold rolling optionally comprises an intermediate annealing;
h) Decarburization annealing of the cold strip;
i) Applying an annealing separator onto at least one surface of the cold strip;
j) Final annealing of the cold strip at a maximum soaking temperature of at least 1076° C. but less than 1247° C.;
k) Optionally coating of the annealed cold strip with an electric insulation coating and annealing of the insulation coated cold strip;
l) Optionally performing domain refinement of the coated cold strip.

The method of the invention may comprise further steps that are known to the skilled person and that are usually performed when producing grain-oriented electrical steel sheets.

The invention is based here on the realization that good mechanical properties, namely an increased yield strength, and ideal polarizations of a grain-oriented electrical steel strip according to the invention can be ensured by carefully controlling the temperatures in steps b) and e) of the process. It was found that depending on the content of the grain boundary segregating elements Cu, P and Mg in the steel slab different temperatures T1 to T3 for step b) and a different temperature CT for step e) should be selected.

It was observed that the GOES generally crack along the grain boundaries. It therefore appears that the grain boundaries are the weak points in the GOES, which decisively influence the yield strength of the GOES.

In this context, the invention makes use of the fact that by controlling the furnace temperature in step b) and the coiling temperature in step e) specific intermetallic phases can be eliminated and specific intermetallic phases can be deliberately avoided so that they are not deposited at grain boundaries. By segregating the right intermetallic phases, the inventors can strike a balance between Zener pinning and grain growth during final annealing in step j), which in turn allows the yield strength to be manipulated without negatively affecting the polarization.

The combination of measures according to the invention in the production of the grain-oriented electrical steel strip, especially in steps b) and e) of the method of the invention, make it possible to reliably achieve improved yield strength while at the same time achieving excellent magnetic properties of the grain-oriented electrical steel sheet.

In step a) of the method of the invention a steel slab is provided with a composition comprising, in wt.-%,
Si: 2.0 to 4.0,
C: 0.01 to 0.10,
Alₛₗ: 0.01 to 0.065,
N: 0.003 to 0.015,
Mn: 0.01 to 0.5,
at least one element selected from the group consisting of P, Cu, Mg, with the following contents, in wt. %,
P: 0.005 to 0.10,
Mg: 0.0003 to 0.0020,
Cu: 0.001 to 0.50;
optionally one or more elements selected from the group consisting of S, Se, Sn, Sb, Bi, Ni, Cr, Co, Mo, wherein the individual content of each of these elements is 0.005 to 0.2 wt.-%;
optionally one or more elements selected from the group consisting of As, B, V, Nb, Te, Ti, wherein the individual content of each of these elements is 0.0003 to 0.1 wt.-%;
the remainder of the composition being Fe and unavoidable impurities;
2.0 to 4.0% by weight Si is present in the steel slab provided in step a) according the method of the invention. A silicon content of 2.5 to 3.5% by weight has proven to be especially advantageous regarding the magnetic properties of a grain-oriented steel sheet according to the invention. Si is needed to improve the permeability of the GOES. A Si content below 2.0% by weight is insufficient for getting a high permeability and thus a low iron loss. If the Si content is above 4.0% by weight, the workability of the sheet is degraded, meaning the sheet is more brittle and more likely to break during cold rolling or other process steps.

According to the present invention, the amount of C in the steel slab provided in step a) is 0.01 to 0.10% by weight, particularly preferably 0.03 to 0.08% by weight. C is used to improve the hot rolled structure of the steel by promoting the formation of austenite. Additionally, C is needed during cold rolling to act an inhibitor for dislocation movements, thus acting as a driver for recrystallization. Therefore, the C amount should be at least 0.01% by weight. Too high C amounts above 0.10% by weight, however, lead to problems during decarburization annealing and remaining C in the final GOES leads to increased iron loss and has to be avoided.

0.01 to 0.065% by weight of Alₛₗ is present in the steel slab provided in step a) according to the method of the invention. An Alₛₗ content of 0.015 to 0.050, by weight has proven to be especially advantageous regarding an optimal content and grain size of inhibitor particles that inhibit the grain growth and result in a favorable grain orientation of the finished GOES. An Alₛₗ content below 0.01% results in few inhibitor particles and thus to a weak inhibition of grain growth during bell anneal. A too high amount of aluminum of more than 0.065% leads to coarse inhibitor particles, which show a weak inhibition as well.

According to the present invention, N is present in the steel slab provided in step a) in an amount of 0.003 to 0.015% by weight, particularly 0.0035 to 0.013% N. N is needed as an inhibitor forming element, which together with Al leads to the formation of AlN. If the N content is lower than 0.003%, the inhibition is insufficient. Higher N contents than 0.015% lead to problems during rolling and a bad surface quality.

0.01 to 0.5 weight % Mn is present in the steel slab provided in step a) of the method of the invention. A manganese content of 0.05 to 0.3, preferably of 0.05 to 0.25% by weight has proven to be especially advantageous. The addition of at least 0.01% by weight of Mn decreases the iron loss by increasing the specific resistance of GOES and improves the hot workability of the steel. A Mn content above 0.5% by weight decreases the magnetic flux density of the GOES and should therefore be avoided.

According to the present invention the composition of the steel slab comprises at least one element selected from the group consisting of P, Cu, Mg, with the following contents, in wt. %, P: 0.005 to 0.10, Mg: 0.0003 to 0.0020, Cu: 0.001 to 0.50. It has been found that addition of more than 0.1 wt. % P, 0.0020 wt. % Mg and/or 0.50 wt. % Cu can lead to negative interference during decarburization annealing in step h) by harming the interaction of recovery and recrystallization of the cold-rolled structure.

In case the composition of the steel slab comprises less than 0.005 wt. % P, 0.0003 wt. % Mg and/or 0.001 wt. % Cu this can lead to insufficient grain growth selection in step j) resulting in inferior Orowan hardening and a decrease in yield strength.

The sum of the content of unavoidable impurities in the steel slab provided in step a) of the method of the present invention is preferably restricted to less than 0.5% by weight, more preferably to less than 0.3% by weight.

In addition to Fe, Si, C, Alₛₗ, N, Mn and at the at least one element selected from the group of P, Mg, Cu and unavoidable impurities, the steel slab provided in step a) according to the method of the invention optionally comprises one or more elements selected from the group consisting of S, Se, Sn, Sb, Bi, Ni, Cr, Co, Mo, wherein the individual content of each of these elements is 0.005 to 0.2 wt.-% and/or optionally one or more elements selected from the group consisting of As, B, V, Nb, Te, Ti, wherein the individual content of each of these elements is 0.0003 to 0.1 wt.-%.

For example, according to the method of the present invention, the individual content of S, Se, Sb, Bi, Ni, Co, Mo, if present in the grain-oriented electrical steel sheet, may amount to 0.01 to 0.1 wt.-% and the individual content of Sn and Cr, if present in the grain-oriented electrical steel sheet, may amount to 0.01 to 0.15 wt.-%.

Furthermore, according to the method of the present invention, the individual content of As, B, V, Nb, Te, Ti, if present in the grain-oriented electrical steel sheet, may amount to 0.0003 to 0.08 wt.-%.

In step b) of the method of the invention the steel slab provided in step a) is heated in a furnace to a temperature of at least T1, T2 or T3, in K, and less than 1723 K wherein the temperature T1 indicates the minimum heating temperature for a steel slab containing Cu and P and the temperature T1 is calculated using the following equation:

$$T 1 [ in K ] = 1200 + 350 * Cu + 2056 * P ;$$

wherein the temperature T2 indicates the minimum heating temperature for a steel slab containing P and Mg and the temperature T2 is calculated using the following equation:

$$T 2 [ in K ] = 1200 + 250 * P + 10000 * Mg ;$$

wherein the temperature T3 indicates the minimum heating temperature for a steel slab containing Cu and Mg and the temperature T3 is calculated using the following equation:

$$T 3 [ in K ] = 1200 + 350 * Cu + 10000 * Mg ;$$

wherein the minimum heating temperature for a steel slab containing Cu, Mg and P corresponds to the lowest temperature selected from the calculated temperatures T1, T2 and T3. Preferably the heating in step b) of the method of the present invention is carried out for a duration of 30 min to 600 min. A duration of less than 30 min leads to insufficient and inhomogeneous heating through resulting in difficult hot workability. A duration of more than 600 min is uneconomic and can lead to unwanted growth of inhibitor particles resulting in an insufficient grain growth selection in step j).

In case the steel slab provided in step a) is heated in a furnace to a temperature below the minimum heating temperature T1, T2 or T3 specified above intermetallic phases are agglomerated below the surface at the grain boundaries, which impedes Bloch wall movement and leads to poor polarization of the GOES due to deformation of the hysteresis curve. Temperatures above 1723 K lead to poor hot workability as rollers become soiled due to liquid slag.

In step c) of the method of the invention the steel slab is continuously hot rolled into a hot strip, wherein i. the time between the end of rough rolling and the start of final hot rolling is less than 15 s or ii, wherein between the end of rough rolling and the start of final hot rolling coiling and/or intermediate annealing of the rough rolled hot strip is carried out. The hot strip achieved in step c) of the method according to the invention preferably has a thickness of 0.5 to 4.0 mm, more preferably 1.5 to 3.5 mm, most preferably 1.8 to 2.7 mm. Continuous hot rolling as mentioned herein in the first alternative i. is characterized by a short time period between an optional rough rolling and the final hot rolling, wherein the optional rough rolling can be performed in a reversing manner, meaning that for each rough rolling step the rolling direction can be changed by 180°. The time between rough rolling and final hot rolling should be kept as short as possible as the temperature of the coil decreases with time and a high temperature is needed for the final hot rolling. Therefore, the time period between rough rolling and the start of final hot rolling is less than 15 s, preferably the time between the end of rough rolling and the start of final hot rolling is less than 10 s. Longer time periods lead to an inhomogeneous heat distribution across the strip dimensions and to undesired particle dissolution. In the second alternative embodiment ii. of the method of the invention during continuous hot rolling the steel slab is hot rolled into a hot strip, wherein between the end of rough rolling and the start of final hot rolling coiling and/or intermediate annealing of the rough rolled hot strip is carried out. In case an intermediate annealing is performed, the time between the end of rough rolling and the start of hot rolling is above 15 s. However, as the coil is subjected to an intermediate annealing between rough rolling and final hot rolling a decrease in coil temperature can be avoided. Preferably, the time between end of intermediate annealing and start of final hot rolling is below 15 s to securely avoid a decrease in temperature and the problems resulting therefrom. In case coiling of the hot strip is carried out this serves to minimize the temperature difference across its length, i.e. between head and tail, of the rough rolled hot strip. Coiling of the rough rolled strip also leads to a significantly slower temperature decrease of the strip and ensures a homogeneous heat distribution along the strip length and width. Preferably, a coil box is used for coiling the rough rolled strip.

In step d) of the method of the invention the hot strip obtained in step c) is cooled by vapor and/or liquid spray cooling, wherein the cooling starts at most 5 s after the end of the last final hot rolling step, preferably within 2 s after the final hot rolling step. An immediate cooling after final hot rolling is needed to prevent grain growth and recovery, which would negatively impact the primary recrystallization during step h). By using vapor and/or liquid spray cooling, cooling rates higher than 50 K/s can be achieved, which are needed for the same reasons as mentioned above, i.e. to prevent grain growth and recovery. Preferably, the cooling rate from the end of final hot rolling to the end of vapor and/or liquid spray cooling is higher than 40 K/s, more preferably between 60 K/s and 100 K/s. Higher cooling rates are not preferred as these increase the risk for edge cracks of the hot rolled coils.

The coiling of the hot strip according to working step e) of the method of the present invention is carried out at a coiling temperature CT, wherein CT conforms to the following equation:

$$TX * 0.66 \leq CT \leq TX * 0.83 ,$$

wherein TX, in K, is selected from T1, T2 or T3 calculated according to step b) above.

It was found by the inventors that if the coiling temperature is below TX*0.66 no decoration of the grain boundary can be achieved and the mechanical properties, in particular the desired yield strength of the GOES cannot be obtained. On the other hand, in case the coil temperature is above TX*0.83 the grain boundaries are fully decorated, which also leads to poor mechanical properties of the final GOES.

In step f) of the method according to the invention, the hot strip is annealed. The annealing in step f) is preferably carried out at a temperature T4 that conforms to the following equation:

$$T 4 > ( A * CT + B * TX ) / 34.1 ,$$

wherein A is 24.3 and B is 19.5. Using a temperature T4 that conforms to this equation avoids the dissolution of inhibitor particles or carbides, which could otherwise result in an insufficient inhibiting effect and a poor grain growth selection in step j).

According to step g) of the method of the invention the hot strip is cold rolled in one or more steps into a cold strip, wherein the cold rolling optionally comprises an intermediate annealing. The hot rolled strip may be for example be cold rolled in at least three passes with a temperature T_{CR} during the third pass in a single-stage rolling or during the last pass prior to an intermediate annealing in a multi-stage rolling, to obtain a cold rolled strip. As used herein “single stage rolling” is cold-rolling in at least three passes, wherein no intermediate annealing takes place between individual passes. As used herein “multi-stage rolling” is cold rolling in at least three passes, wherein the hot-rolled strip is cold rolled to an intermediate thickness, an intermediate annealing takes place, and after the intermediate annealing the strip is further cold-rolled to the final thickness. Methods for cold rolling a grain-oriented steel strip are generally known to the skilled expert as well and, for example, described in WO 2007/014868 A1 and WO 99/19521 A1. Typically, an intermediate annealing is performed in a temperature range of 700 to 1150° C., preferably 800 to 1100° C., under an atmosphere which dew point is set to 10 to 80° C. Typical annealing times are 30s to 900 s. Installations with which such annealing can be performed are generally known and disclosed, for example, in WO 2007/014868 A1 and WO 99/19521 A1. The temperature T_{CR} as used herein is the temperature of the strip determined during the third pass of single stage rolling or during the last pass of multi stage rolling prior to intermediate annealing. Preferably, the temperature T_{CR} is between 15° and 450° C., more preferably between 20° and 350° C.

Typically, the thickness of the cold strip is 0.15 to 0.5 mm, preferably a maximum thickness of 0.35 mm, preferably of ≤0.27 mm at most or of 0.23 mm at most, are especially favorable.

In working step h) of the method according to the invention decarburization annealing of the cold rolled strip obtained in step g) takes place. This decarburization annealing may optionally include a nitriding treatment. The decarburization annealing is preferably carried out at temperatures in the range of 600 to 950° C., more preferably of 600 to 900° C. The duration t_{A} of the decarburization annealing is preferably 30 to 300 s. The decarburization annealing is typically carried out using a high dew point atmosphere with a dew point between 4° and 80° C., preferably between 4° and 65° C. A dew point of more than 80° C. cannot be set in industrial settings, while with a dew point below 40° C. the resulting oxide layer becomes too dense and all surface-controlled chemical reactions, e.g. decarburization, nitriding, de-nitriding, can no longer take place as desired. The atmosphere may comprise 5 to 95 Vol.-% H₂, the reminder being nitrogen or any inert gas or a mix gas.

If a nitriding treatment is to be performed the annealing can be carried out under an atmosphere, which comprises N₂ or N-comprising compounds, for example NH₃. Annealing and nitriding can be conducted in two separate steps one after the other with the annealing being performed at first. As an alternative annealing and nitriding can be performed simultaneously.

If nitriding is performed in working step h) the conditions of the nitriding treatment should be adjusted such that a nitriding degree of up to 850 ppm, preferably up to 400 ppm, more preferably 20 to 400 ppm, is achieved. The nitriding degree is calculated as the difference between the nitrogen content of the steel strip before the final annealing (working step j)) minus the nitrogen content before the decarburization annealing (working step h)). The nitrogen content can be determined by usual means, such as using a 736 analyzer offered by Leco Corporation, St. Joseph, USA.

In step i) of the method according to the invention an annealing separator is applied onto at least one surface of the cold strip obtained in step b). Typically, the annealing separator comprises MgO and optionally oxides and mixed oxides of iron, aluminum, titanium, magnesium and/or silica. The annealing separator comprising MgO and optionally oxides and mixed oxides of iron, aluminum, titanium, magnesium and/or silica applied to the cold-rolled steel strip to produce the forsterite layer during annealing in step j) in a manner known per se can consist of at least 70% by weight MgO, optionally up to 25% by weight of oxides and mixed oxides of iron, aluminum, titanium, magnesium and/or silica and can further contain up to 5% by weight additives, based on the total dry weight of the annealing separator. These additives may be, for example, elements like Ca, B and Sr, ammonium chloride or antimony chloride, and other salts like magnesium sulfate or sodium chloride, the addition of which controls the density of the subsequent forsterite layer and the gas exchange between the annealing atmosphere during high-temperature annealing and the metal.

In step j) of the process according to the invention the cold rolled strip obtained in step h) and coated with the annealing separator in step i) undergoes a final annealing during which the forsterite layer is formed and secondary recrystallization occurs. The final annealing of the cold strip in step j) according to the method of the invention takes place at a maximum soaking temperature of at least 1076° C. but less than 1247° C. Temperatures below 1076° C. are insufficient for dissolving residual elements such as N or S, which would otherwise deteriorate the final magnetic properties of the GOES. Final annealing temperatures above 1247° C. lead to unwanted physical deformations of the steel strip due to decreased hardness of the steel.

This final annealing can also be carried out in a manner known per se. For this purpose, the cold-rolled steel strip obtained after step h) and coated with the annealing separator in step i) can be wound into a coil and kept in a bell furnace for 10-200 hours at a maximum soaking temperature of 1076-1247° C. under an atmosphere consisting of at least 50% H₂. For example, the strip or sheet that is obtained after step i) can be rapidly heated to a maximum soaking temperature of 1150° C. or above, wherein maximum soaking temperatures of at least 1200° C. are particularly advantageous. The heating and soaking are preferably carried out under a protective gas atmosphere, which, for example, comprises H₂. Particularly preferably, the heating to and soaking at the respective soaking temperature is performed under an atmosphere which comprises 5 to 95 Vol.-% H₂, the reminder being nitrogen or any inert gas or a mix gas, the local dew point of the atmosphere being at least 10° C. The soaking time, during which the high temperature soaking is carried out in this way, can be determined in a common manner, which is well known to the expert. By the soaking performed in this way atoms of elements are removed, which would deteriorate the properties of the grain-oriented electrical steel sheet. These elements are in particular N and S.

After the final annealing the steel strip is cooled down in a common manner, e.g. by natural cooling, to room temperature.

In step j) of the process according to the invention the secondary recrystallization takes place, which ensures that the grain-oriented steel sheet processed in this way is prepared to reliably develop the optimized properties of a grain-oriented steel sheet according to the invention as outlined above.

In addition, according to a preferred embodiment of the method of the invention, after step j) the steel strip is cleaned, and optionally pickled. Methods with which the steel strip is pickled are known to the skilled expert. For pickling the steel strip can be treated with an aqueous acidic solution. Suitable acids are for example phosphoric acid, sulfuric acid and/or hydrochloric acid.

In optional step k) of the method of the invention the annealed cold strip obtained in step j) of the method of the invention is coated with an electric insulation coating and the insulation coated cold strip is annealed. The insulating layer is preferably applied on at least one side of the GOES. The method for applying the insulating layer is known to the artisan and can be found in e.g. EP 2 902 509 B1 and EP2 954 095 A1. An insulation coating applied to a grain oriented electrical steel product has a positive effect on minimization of the hysteresis losses. The insulation coating can transfer tensile stresses to the base material, which not only improves the magnetic loss values of the grain oriented electrical steel product but also reduces the magnetostriction, thereby having in turn a positive effect on the noise behavior of the finished transformer. Formation of the insulation coating involves applying an aqueous solution of metallic phosphate containing colloidal silica and optional chromium compounds onto the surface of the steel sheet and baking the same at temperatures in the range of 800° C. to 950° C. for 10 to 600 s.

According to optional step 1) of the method of the invention a domain refinement, preferably transverse to the rolling direction, is performed. The method for domain refinement by laser or electron beam treatment is known to the skilled person and can be found in e.g. in EP 2 675 927 A1. For example, in the course of laser treatment, linear deformations, which are arranged with a spacing, are formed into the surface of the flat steel product by means of a laser beam emitted by a laser beam source, thereby decreasing the length of the domains and reducing the losses of the grain-oriented electrical steel sheet.

According to the present invention, at the end of the method explained above, the grain-oriented electrical steel has a yield strength in the rolling direction of at least 340 MPa determined according to DIN EN ISO 6892-1, a polarization J500 of at least 1.85 and preferably a polarization J2500 of at least 1.93.

The chemical composition of the grain-oriented electrical steel is preferably as follows: Si: 2.0 to 4.0, Mn: 0.01 to 0.5, at least one element selected from the group consisting of P, Cu, Mg, with the following contents, in wt. %, P: 0.005 to 0.10, Mg: 0.0003 to 0.0020, Cu: 0.001 to 0.50; optionally one or more elements selected from the group consisting of Se, Sn, Sb, Bi, Ni, Cr, Co, Mo, wherein the individual content of each of these elements is 0.005 to 0.2 wt.-%; optionally one or more elements selected from the group consisting of As, B, V, Nb, Te, Ti, wherein the individual content of each of these elements is 0.0003 to 0.1 wt.-%; the remainder of the composition being Fe and unavoidable impurities.

In contrast to the composition of the steel slab used in step a) of the method according to the invention the composition of the resulting grain-oriented electrical steel does contain Alₛₗ, C, N and S only as unavoidable impurities as these elements are dissolved out of the steel during steps h) and j) of the method of the invention.

The grain oriented electrical steel sheet may also be characterized by a coarse grain structure, which shows a medium grain size, which can be measured by any known method such as line intersection method or other methods according to DIN EN ISO 643, of several mm, preferably a medium grain size of at least 10 mm and less than 50 mm.

According to the present invention, the grain-oriented electrical steel sheets can be prepared in any format, like steel strips that are provided as coils, or cut steel pieces that are provided by cutting these steel pieces from the steel strips. Methods to provide coils or cut steel pieces are known to the skilled expert.

The grain-oriented electrical steel sheet produced according to the method of the present invention shows improved mechanical properties, in particular improved yield strength in the rolling direction, and at the same time excellent magnetic properties, in particular excellent polarization, in comparison to grain-oriented electrical steel sheets according to the prior art.

Accordingly, the grain-oriented electrical steel sheet according to the invention is in particular useful for the manufacture of parts for electric motors.

A preferred use of the grain-oriented electrical steel sheet of the present invention is as material for the manufacture of stator or rotor core for radial or axial flux motors.

To manufacture such stator or rotor core stacks of the grain-oriented electrical steel sheet are typically formed by laminating the GOES sheets together with a resin, for example, a coating as described in DE 10 2015 012172 A1 or a backlack type resin.

For the lamination of the GOES sheets temperatures below 230° C. are usually used. The optimal duration of the lamination depends on the lamination temperature used and on the thickness of the stack to be laminated and is typically adapted depending on the stack geometry and the type of heating used. The exact conditions for the manufacturing of the resin coating depend on the resin type used and can be found in the respective data sheets of the resin manufacturer.

Usually, the optimal duration for the lamination increases with decreasing lamination temperature and/or increasing laminated stack thickness. For example, lamination of a thin stack of GOES at a lamination temperature of 200° C. using a lamination time of 2 minutes may be sufficient, while for laminating a thicker stack of GOES a lower temperature of 180° C. for a duration of 1 hour or at 140° C. for a duration of 2 hours may be preferable. The temperatures mentioned for the lamination are not the furnace temperatures, but the core temperatures of the stack and the holding time is the time that elapses between reaching the core temperature and removal from the furnace.

The lamination is usually carried out using a pressure between 150 to 300 N/cm³.

Another aspect of the present invention is a laminated stack of grain-oriented electrical steel sheets, wherein the stack comprises at least two grain-oriented electrical steel sheets according to the invention laminated together with a resin.

Typically, a laminated stack of grain-oriented electrical steel sheets comprises at least 2 or at least 3 grain-oriented electrical steel sheets according to the invention laminated together with a resin.

The resin for laminating the grain-oriented electrical steel sheets together is not particularly limited. Any resin known to the skilled person for this purpose can be used. Preferably, the resin for laminating the grain-oriented electrical steel sheets together is selected from a backlack type resin or a coating as described in DE 10 2015 012172 A1. These resin types are known to the skilled person and are described, e.g., in DE 10 2015 012172 A1.

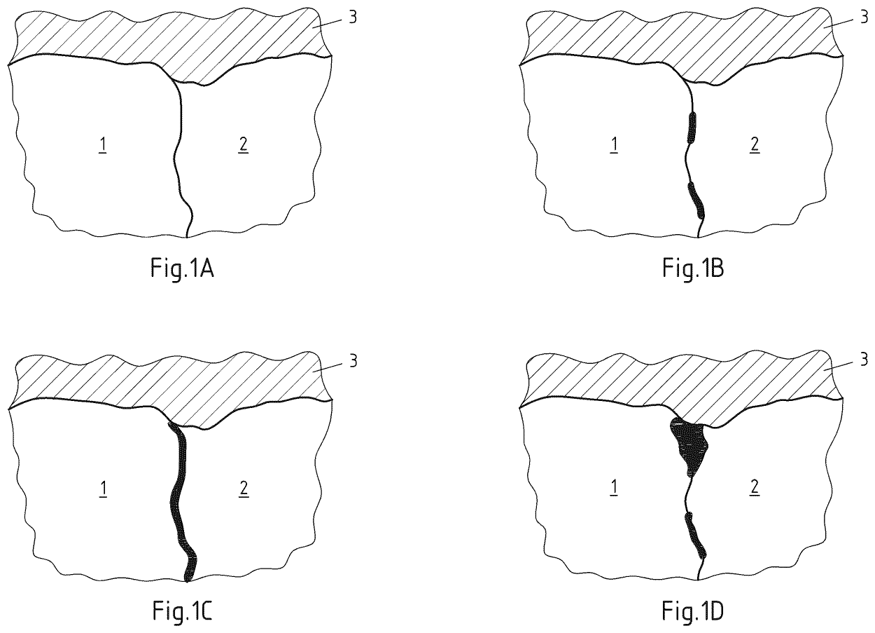

FIGS. 1A-1D show schematic illustrations of four differently decorated grain boundaries A to D. Grain boundary A corresponds to a GOES produced according to the prior art. The grain boundary between grain 1 and grain 2 is not decorated with any intermetallic phases. This results in good polarization but poor mechanical properties. Grain boundary B corresponds to a GOES produced according to the invention, wherein the boundary between grain 1 and grain 2 is partially decorated with specific intermetallic phases. This results in high polarization and good mechanical properties. The excessively decorated grain boundary C exhibits high polarization but leads to poor mechanical properties. In grain boundary D the intermetallic phases are agglomerated below the surface, which impedes Bloch wall movement and leads to poor polarization due to deformation of the hysteresis curve. The mechanical properties, however, may be unaffected or improved, depending on the degree of decoration. It was found by the inventors of the present application that in case that the coiling temperature is too low a situation at the grain boundary as shown in A is achieved, i.e. no decoration of the grain boundary can be observed. Without being bound by theory it appears that in case the coil temperature is too low, i.e. lower as the lower end of the temperature range specified in step e) of the method of the invention, the diffusion of segregating elements to the grain boundary is largely suppressed. On the other hand, a coil temperature that is too high, i.e. higher as the higher end of the temperature range specified in step e) of the method of the invention, leads to a fully decorated grain boundary C due to excessive diffusion of the segregating elements. In addition, the inventors have found that in case the slab temperature to which the slab is heated prior to hot rolling in step b) of the method of the invention is too low, i.e. below the minimum temperatures T1, T2 or T3 specified in step b) of the method of the invention, this leads to grain boundary D, wherein the intermetallic phases are agglomerated below the surface. It appears that in such a case non-dissolved agglomerations accumulate on the grain boundary. A similar situation is also observed in case the hot strip annealing temperature in step f) of the method of the invention is too low.

Experiments have been carried out to demonstrate the effect of the invention.

In these experiments, 24 samples of grain-oriented electrical steel sheets were produced using steel slabs having the composition as shown in Table 1. These slabs were heated using the furnace temperature Tx according to Table 2, continuously hot-rolled into a hot strip having a thickness of 2.2 mm, wherein the time between the end of rough rolling and the start of final hot rolling was less than 15 s, cooled, coiled into a coil using the coiling temperature CT as shown in Table 2, and annealed at the hot rolled strip annealing temperature T4 as shown in Table 2, cooled to a temperature of 900° C. and then to room temperature. The cooled hot strips were cold rolled in a single stage into cold strips having a final thickness of 0.22 mm. The cold strips underwent decarburization annealing including a nitriding treatment at an annealing temperature of 850° C. After application of an annealing separator mainly comprising MgO onto the strip surface, final annealing of the coated decarburization annealed cold strips with a temperature of 1210° C. to form a Goss texture was carried out. The final annealed cold strips were coated with an electric insulation coating containing a metal phosphate, colloidal silica and a chromium compound, and subsequently annealed for relieving stresses. Domain refinement of the coated cold strips was carried out.

For each of the samples 1 to 24 the following parameters and properties are indicated in Table 3:
the composition of the steel slab used;
the parameter set of Tx, CT and T4 used;
the yield strength determined according to DIN EN ISO 6892-1 in MPa;
the polarizations J500 and J2500 are determined using a single sheet tester according to IEC 60404-3:1992.

Furthermore, it is indicated in Table 3 whether the Example is an Example according to the invention.

The experiments clearly show that those Examples, which fulfill the parameters Tx, CT and T4 of the method of the invention exhibit good yield strength in the rolling direction of above 345 MPa, and good polarization, i.e. J500 values of at least 1.85 and J2500 values of at least 1.93. The Comparative Examples, which do not meet the requirements of the invention, show either insufficient yield strength and/or insufficient polarization.

TABLE 1
(amounts given in wt.-%, the balance being
iron and unavoidable impurities)

| Composition | Si | C | Alₛₗ | N | Mn | Cu | P | Mg |
|---|---|---|---|---|---|---|---|---|
| A | 3.2 | 0.05 | 0.025 | 0.010 | 0.110 | 0.000 | 0.025 | 0.0003 |
| B | 3.1 | 0.05 | 0.035 | 0.008 | 0.067 | 0.120 | 0.007 | 0.0000 |
| C | 3.1 | 0.06 | 0.030 | 0.008 | 0.070 | 0.080 | 0.000 | 0.0010 |
| D | 3.1 | 0.06 | 0.035 | 0.009 | 0.190 | 0.200 | 0.015 | 0.0000 |

TABLE 2

| Parameter set | Tx [K] | CT [K] | T4 [K] |
|---|---|---|---|
| 1 | 1250 | 800 | 1350 |
| 2 | 1300 | 920 | 1220 |
| 3 | 1350 | 870 | 1300 |

TABLE 3

| | | Parameter | Yield strength | J500 | J2500 | Inventive |
|---|---|---|---|---|---|---|
| No. | Composition | set | in RD [MPa] | [T] | [T] | example |
| 1 | A | 1 | 347 | 1.858 | 1.936 | YES |
| 2 | A | 1 | 361 | 1.851 | 1.939 | YES |
| 3 | A | 2 | 352 | 1.864 | 1.945 | YES |
| 4 | A | 2 | 344 | 1.862 | 1.936 | YES |
| 5 | A | 3 | 349 | 1.859 | 1.941 | YES |
| 6 | A | 3 | 353 | 1.862 | 1.942 | YES |
| 7 | B | 1 | 321 | 1.840 | 1.921 | NO |
| 8 | B | 1 | 315 | 1.822 | 1.913 | NO |
| 9 | B | 2 | 344 | 1.836 | 1.925 | NO |
| 10 | B | 2 | 342 | 1.839 | 1.928 | NO |
| 11 | B | 3 | 355 | 1.852 | 1.933 | YES |
| 12 | B | 3 | 350 | 1.858 | 1.942 | YES |
| 13 | C | 1 | 326 | 1.850 | 1.937 | NO |
| 14 | C | 1 | 333 | 1.864 | 1.945 | NO |
| 15 | C | 2 | 338 | 1.818 | 1.912 | NO |
| 16 | C | 2 | 342 | 1.820 | 1.923 | NO |
| 17 | C | 3 | 358 | 1.868 | 1.938 | YES |
| 18 | C | 3 | 359 | 1.857 | 1.945 | YES |
| 19 | D | 1 | 323 | 1.837 | 1.925 | NO |
| 20 | D | 1 | 326 | 1.834 | 1.926 | NO |
| 21 | D | 2 | 343 | 1.836 | 1.927 | NO |
| 22 | D | 2 | 348 | 1.825 | 1.921 | NO |
| 23 | D | 3 | 355 | 1.861 | 1.932 | YES |
| 24 | D | 3 | 346 | 1.855 | 1.939 | YES |

1. A method of producing a grain-oriented electrical steel strip by thin slab continuous casting, comprising the following steps:
a) providing a steel slab with a composition comprising, in wt.-%,
Si: 2.0 to 4.0,
C: 0.01 to 0.10,
Al-acid soluble: 0.01 to 0.065,
N: 0.003 to 0.015,
Mn: 0.01 to 0.5,
at least one element selected from the group consisting of P, Cu, and Mg, with the following contents, in wt. %,
P: 0.005 to 0.10,
Mg: 0.0003 to 0.0020,
Cu: 0.001 to 0.50;
optionally one or more elements selected from the group consisting of S, Se, Sn, Sb, Bi, Ni, Cr, and Co, wherein the individual content of each of these elements is 0.005 to 0.2 wt.-%;
optionally one or more elements selected from the group consisting of As, B, V, Nb, Te, Ti, and Mo, wherein the individual content of each of these elements is 0.0003 to 0.1 wt.-%; and
the remainder of the composition being Fe and unavoidable impurities;
b) heating of the steel slab in a furnace to a temperature of at least T1, T2 or T3, in K, and less than 1723 K;
wherein the temperature T1 indicates the minimum heating temperature for a steel slab containing Cu and P and the temperature T1 is calculated using the following equation:
$$T1 = 1200 + 350 * Cu + 2056 * P ;$$
wherein the temperature T2 indicates the minimum heating temperature for a steel slab containing P and Mg and the temperature T2 is calculated using the following equation:
$$T2 = 1200 + 250 * P + 10000 * Mg ;$$
wherein the temperature T3 indicates the minimum heating temperature for a steel slab containing Cu and Mg and the temperature T3 is calculated using the following equation:
$$T3 = 1200 + 350 * Cu + 10000 * Mg ;$$
wherein the minimum heating temperature for a steel slab containing Cu, Mg and P corresponds to the lowest temperature selected from the calculated temperatures T1, T2 and T3;
c) continuous hot rolling of the steel slab into a hot strip, wherein:
i. a time between an end of rough rolling and a start of final hot rolling is less than 15 s or
ii, wherein between the end of rough rolling and the start of final hot rolling, coiling and/or intermediate annealing of the rough rolled hot strip is carried out;
d) cooling the hot strip by vapor and/or liquid spray cooling;
e) coiling the hot strip at a coiling temperature CT, wherein CT conforms to the following equation:
$$TX * 0.66 \leq CT \leq TX * 0.83 ,$$
wherein TX, in K, is selected from T1, T2 or T3 calculated according to step b) above;
f) annealing the hot strip;
g) cold rolling the hot strip in one or more steps into a cold strip, wherein the cold rolling optionally comprises an intermediate annealing;
h) decarburization annealing of the cold strip;
i) applying an annealing separator onto at least one surface of the cold strip;
j) final annealing of the cold strip at a maximum soaking temperature of at least 1076° C. but less than 1247° C.;
k) optionally coating of the annealed cold strip with an electric insulation coating and annealing of the insulation coated cold strip and;
l) optionally performing domain refinement of the coated cold strip.

2. The method of producing a grain-oriented electrical steel strip according to claim 1, wherein in step f) the annealing of the hot strip is carried out at a temperature T4 that conforms to the following equation:
$$T 4 > ( A * CT + B * TX ) / 34.1 ,$$
wherein A is 24.3 and B is 19.5.

3. The method of producing a grain-oriented electrical steel strip according to claim 1, wherein the heating in step b) is carried out for a duration of 30 min to 600 min.

4. The method of producing a grain-oriented electrical steel strip according to claim 1, wherein the hot strip resulting from step c) has a final thickness of 0.5 to 4 mm.

5. The method of producing a grain-oriented electrical steel strip according to claim 1, wherein the cooling of the hot strip resulting from step c) starts at most 5 s after the end of the last final hot rolling step.

6. The method of producing a grain-oriented electrical steel strip according to claim 1, wherein the cold strip resulting from step g) has a final thickness of 0.15 to 0.50 mm.

7. The method of producing a grain-oriented electrical steel strip according to claim 1, wherein the decarburization annealing in step h) is carried out at temperatures in the range of 600 to 950° C.

8. The method of producing a grain-oriented electrical steel strip according to claim 1, wherein the duration t_{A} of the decarburization annealing in step h) is 30 to 300 s.

9. The method of producing a grain-oriented electrical steel strip according to claim 1, wherein the decarburization annealing in step h) is carried out using a high dew point atmosphere with a dew point between 4° and 80° C.

10. The method of producing a grain-oriented electrical steel strip according to claim 1, wherein the final annealing in step j) is carried out for 10-200 hours.

11. A grain-oriented electrical steel, wherein the grain-oriented electrical steel has a yield strength in a rolling direction of at least 340 MPa determined according to DIN EN ISO 6892-1 and a polarization J500 of at least 1.85.

12. The grain-oriented electrical steel according to claim 11, wherein the grain-oriented electrical steel has a polarization J2500 of at least 1.93.

13. A laminated stack of grain-oriented electrical steel sheets, wherein the stack comprises at least two grain-oriented electrical steel sheets according to claim 11 laminated together with a resin.

14. The laminated stack of claim 13, wherein the resin is selected from a backlack type resin.

15. A part of an electric device comprising a grain-oriented electrical steel strip according to claim 11.

16. A laminated stack of grain-oriented electrical steel sheets, wherein the stack comprises at least two grain-oriented electrical steel sheets produced according to claim 1 laminated together with a resin.

17. The laminated stack of claim 16, wherein the resin is selected from a backlack type resin.

18. A part of an electric device comprising a laminated stack according to claim 13.

19. A part of an electric device comprising a grain-oriented electrical steel strip produced according to claim 1.
